(19) United States
(12) Patent Application Publication
(10) Pub. No.: US 2013/0080486 A1
(43) Pub. Date: Mar. 28, 2013

(54) DISCOVERY OF METADATA FOR MULTIMEDIA CONTENT STREAM TRAFFIC ON A NETWORK

(71) Applicant: Thomas J. Bahnck, Lafayette Hill, PA (US)

(72) Inventor: Thomas J. Bahnck, Lafayette Hill, PA (US)

(73) Assignee: GENERAL INSTRUMENT CORPORATION, Horsham, PA (US)

(21) Appl. No.: 13/240,636

(22) Filed: Sep. 22, 2011

(51) Int. Cl. G06F 17/30

(52) U.S. Cl. 707/804; 707/E17.005

(57) ABSTRACT

A method and apparatus for constructing a metadata database of descriptor of use information relative to video and multimedia transport streams capable of being distributed across a network are provided. The method includes scanning a transport stream to detect metadata directly from the transport stream and collecting additional metadata of the transport stream from at least one headend network device. The metadata and additional metadata obtained for the transport stream is stored in the metadata database. The apparatus may include at least one module for scanning for metadata directly from a video transport stream, for collecting additional metadata known by other network devices, and for populating the metadata database with descriptor of use information for the video transport stream.

### FIELD

Method and apparatus for creating and providing a database of metadata, descriptors of use, and other information concerning multimedia and video content streams distributed across a network are described.

### BACKGROUND

In a multiple service operator (MSO) network, multimedia and video transport stream information, service metadata, encryption/rights data, channel map data, and like descriptors of use are needed for headend and other network devices, such as downstream video processing devices (VPDs), to be able to properly process, provision, distribute, and deliver multimedia content streams to other downstream devices, such as devices located on a customer premise or elsewhere (e.g., in the network cloud). Such data may also be needed by VPDs and other downstream devices to locate and process multimedia content streams available on the network. Conventionally, the information, metadata, descriptors of use, and the like for multimedia and video content streams have been entered manually by operators requiring a relatively labor-intensive process.

The manual entry of such configuration data presents a growing problem because MSO networks are being required to distribute increasing numbers of multimedia and video content streams. For example, these streams may include Internet protocol (IP) traffic, IP multicast traffic, multi-screen video streams, over-the-top (OTT) video streams, broadcast streams, and the like. Still further, such multimedia content streams are typically replicated for localization and ad insertion and are further replicated to provide streams of different resolution, digital rights management (DRM) technologies, and video transport formats required by downstream network client devices.

A MSO may have a metadata server (MS) or the like at a headend of the network. The MS enables the centralized storage and distribution of configuration data, metadata, descriptors of use, and the like for multimedia content streams available on the network. The data stored in the MS is made available to and can be automatically requested by the appropriate network devices or like components and equipment located in the headend or other locations on the network. However, as stated above, the need for the manual entry of such data impedes the creation of a database for a central management server to store and distribute such information.

### SUMMARY

This disclosure describes a method of constructing a metadata database of descriptor of use information relative to video and multimedia transport streams that are capable of being distributed across a network. The method includes electronically scanning a transport stream of interest available on the network to detect metadata directly from the transport stream and electronically collecting additional metadata of the transport stream of interest from at least one network device. The metadata and additional metadata obtained for the transport stream of interest are associated and stored in the metadata database to provide a comprehensive database of descriptor of use information that is automatically and autonomously populated.

This disclosure also describes a signal processing electronic device for automatically and autonomously constructing a metadata database of descriptor of use information of transport streams capable of being distributed across a network. The signal processing electronic device includes at least one module for scanning for metadata directly from a video transport stream of interest, for querying and collecting additional metadata known by other network devices for the video transport stream of interest, and for populating the metadata database with the metadata and additional metadata concerning descriptor of use information for the video transport stream of interest.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates an exemplary MSO network in accordance with an embodiment.

FIG. 2 is a block diagram of headend network devices in accordance with an embodiment.

FIG. 3 is a flowchart of process steps for autonomously populating and building a metadata database for content streams being delivered across a network in accordance with an embodiment.

FIG. 4 is a block diagram illustrating the modes of operation of a metadata server (MS) in accordance with an embodiment.

FIG. 5 is a flowchart illustrating a sequence of steps for the autodiscovery of encryption data, program-specific information (PSI) data, and program ID data in accordance with an embodiment.

FIG. 6 is a flowchart illustrating a sequence of steps for the autodiscovery of channel map data in accordance with an embodiment.

FIG. 7 is a flowchart illustrating a sequence of steps for a video processing device (VPD) to discover multimedia content stream metadata from a metadata server (MS) in accordance with an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

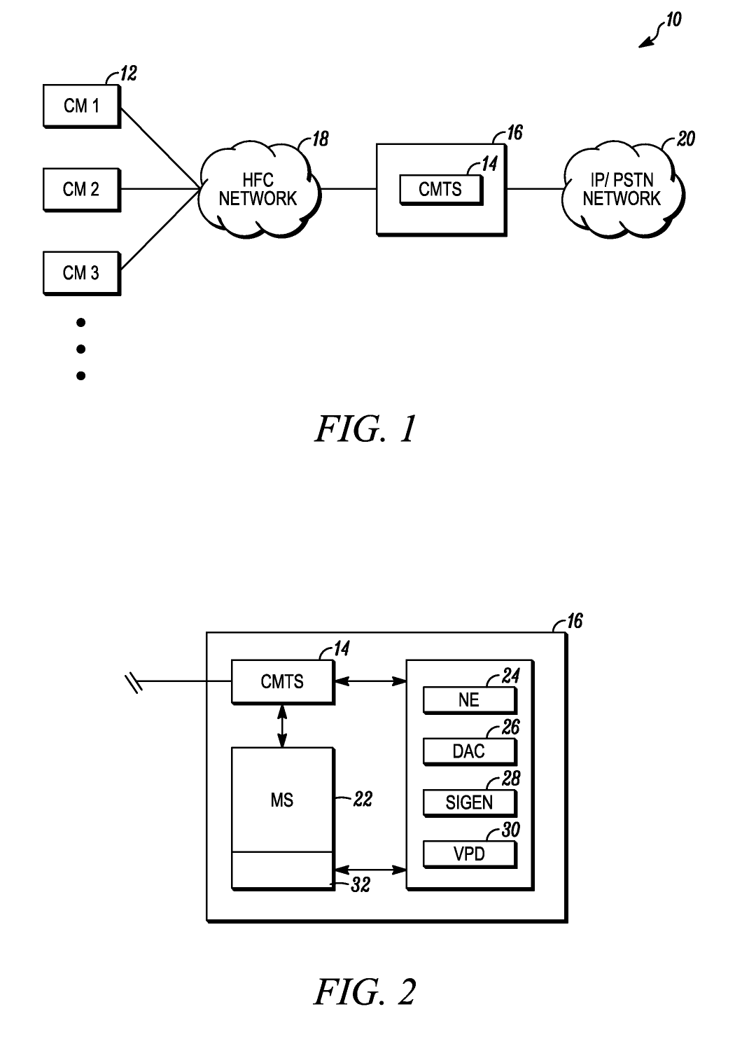

FIG. 1 illustrates an exemplary network 10, such as a MSO network, in which a plurality of cable modems or like network elements 12 are connected to a Cable Modem Termination System (CMTS) 14 or the like at the headend 16 of the network 10. Each cable modem or network element 12 may connect to the CMTS 14 through a cascade of Hybrid Fiber Coax (HFC) components including taps, passives, cabling, nodes, and Radio Frequency (RF) amplifiers indicated generally as HFC network 18 in FIG. 1.

In a typical network 10, the CMTS 14 will be connected to a plurality of network taps, each of which are connected to a plurality of cable modems or network elements 12 such that the CMTS 14 may serve and communicate with many hundreds or more of cable modems or network elements 12. In turn, each cable modem or network element 12 may be in communication with one or more customer premises equipment (CPE) (not shown), i.e., client devices, computers, routers, set top boxes, media centers, gaming consoles, smartphones, and the like. The CMTS 14 may also be connected to numerous program providers, television networks and stations, Internet broadcasters/service providers, and the like 20 for providing content via the headend 16 to the cable modems or network elements 12 and CPE.

FIG. 2 illustrates an example of various components located at the headend 16. Such components can include, but are not limited to, a metadata server (MS) 22, network encryptor (NE) 24, digital addressable controller (DAC) 26, SI Generator (SIGen) 28, and other video processing devices (VPDs) 30 that may be located at the headend 16. Of course, other devices (not shown) may also be located at the headend including various encoders, splicers, groomers, edge decoders, advertisement splicers, servers, and modulators for performing encryption, modulation, upconversion, and like functions at the headend 16 of the network.

In addition to the above noted headend devices, the headend 16 in the embodiment illustrated in FIG. 2 also includes a metadata scanning and database populating module 32. The module 32 may be in the form of hardware, software or a combination of both and may be included as part of another headend device or set of devices, such as forming a part of the metadata server (MS) 22, or may be provided as a standalone device. As previously described, the MS 22 may provide centralized storage and distribution of configuration data, metadata, descriptors of use, and the like information for multimedia content streams available on the network. The function of module 32 is to automatically probe and/or scan traffic passing through the headend 16 and to autonomously build and populate a database of configuration data, metadata, descriptors of use, and the like information which may be stored in the MS 22.

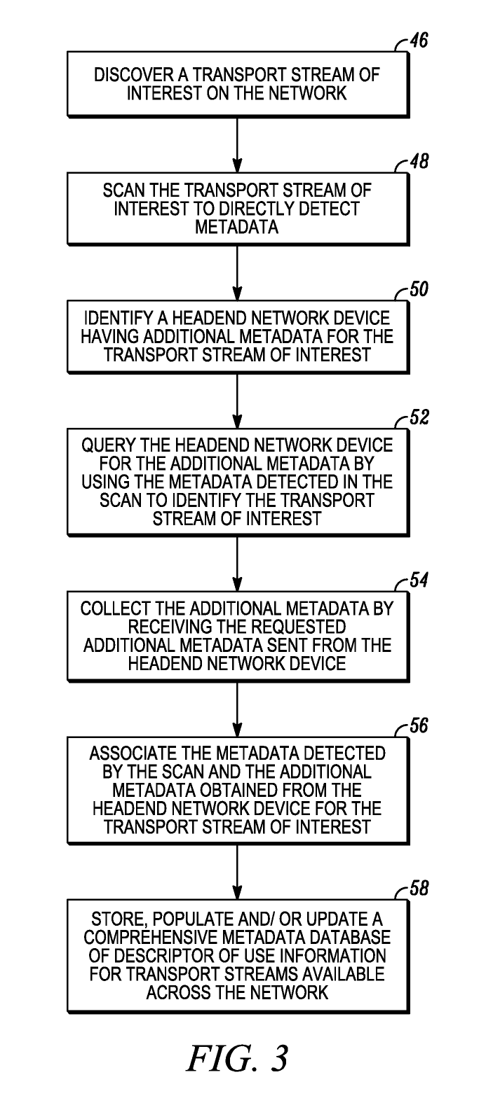

As best shown in FIG. 3, the module 32 may automatically autonomously obtain metadata for any transport stream of interest that is available on the network. For instance, the module 32 can be adapted to discover a transport stream of interest (see step 46) and scan the transport stream as it passes through the headend 16 “on the wire” to read, detect and obtain multimedia content stream properties and other metadata directly from the transport stream (see step 48). For example, an IP transport stream may provide transmission source address and user database protocol (UDP) port and destination address and UDP port. In addition, MPEG-2 traffic may provide program-specific information (PSI), channel map data, and encryption data. Thus, the module 32 can be set to monitor transport streams passing through the headend on the network and parse data of interest from each transport stream to automatically and autonomously populate and update the metadata database stored in the MS 22.

By way of example, a switch in a video path at the headend of the network can be configured to replicate Internet Group Management Protocol (IGMP) and/or Multicast Listener Discovery (MLD) protocol traffic to a port of the module 32, which in turn may form part of the metadata server (MS) 22. IGMP and MLD are communications protocols used by hosts and adjacent routers on IP networks to establish multicast group memberships. The module 32 or metadata server (MS) 22 can infer the active IP multicast streams on a LAN segment by monitoring (i.e., “snooping”) IGMP or MLD membership report messages from downstream VPDs. As an alternative, the module 32 or metadata server (MS) 22 may scan a range of IP multicast addresses (MCAs) to iteratively or momentarily join and analyze the streams. In the above manner, the module 32 can discover new multimedia content streams on the network and automatically add to the database stored in the MS 22.

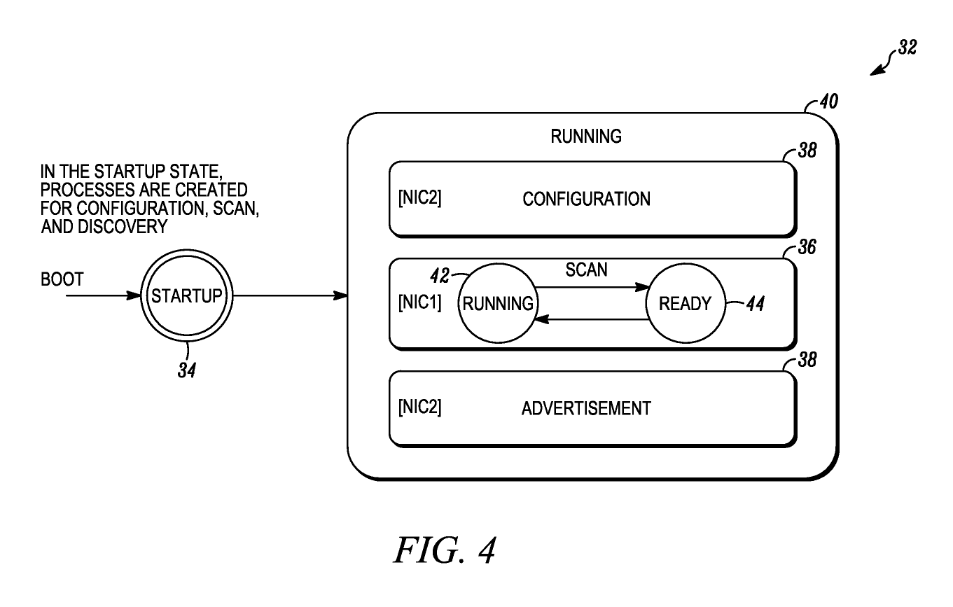

By way of further example, some modes of operation of the module 32 are shown in FIG. 4. Here, the module 32 is shown as a series of Network Interface Cards (NICs) which may reside in the MS 22. In a start-up state 34, processes are created for configuration, scan and discovery operations. In the embodiment shown in FIG. 4, NIC1 36 is dedicated to a scanning process, and NIC2 38 is dedicated to configuration and advertisement processes. All or some of these processes can be performed via different NICs or by the same NIC assuming sufficient bandwidth and processing overhead is provided.

In the running mode of operation 40 of module 32, the above three referenced processes performed by NIC1 36 and NIC2 38 can be performed concurrently. The configuration process provided by NIC2 38 provides a user interface (UI) (e.g. web server) and is able to apply changes to the algorithm used in the scanning process performed by NIC1 36. The scanning process provided by NIC1 36 executes the currently configured scan algorithm. For example, the scan algorithm may be IGMP and/or MLD membership report snooping or MCA range scanning as described above.

Two high-level sub-states of the scanning process may include a running process 42 (i.e., scan is in-process) and a ready process 44 (i.e., scan is imminent). The module 32 transitions from the running sub-state scan process 42 to the ready sub-state scan process 44 after a scan of a particular transport stream is complete and transitions from the ready sub-state scan process 44 to the running sub-state scan process 42 when a configuration change is made requiring a new scan or when a timer lapses which causes the module 32 to autonomously scan on a set interval.

The advertisement process can be performed by NIC2 38 to expose a newly-discovered set of metadata to VPDs. This process can occur in real-time or after a pre-determined time delay. For purposes of this disclosure, “real-time” includes a level of responsiveness that is sufficiently fast to keep up with the rate of scanning of a transport stream as well as a level of responsiveness that tolerates a degree of lateness or built-in delay. Any method can be used to perform the advertisement process, for instance, web services, session announcement protocol/session description protocol (SAP/SDP), or the like.

As shown in FIG. 3, additional metadata that is not provided by the direct scanning of transport streams is also obtained by the module 32 (see steps 50, 52 and 54). The module 32 identifies a headend network device which may provide a source of additional metadata for the transport stream of interest (see step 50) and queries or interrogates the headend network device for the additional information (see step 52). The module 32 uses data obtained from scanning the transport stream of interest to identify the transport stream of interest in the query to the headend network device. This additional information is received and collected by the module 32 from the other headend network device or devices (see step 54), and the additional data is associated with the data collected by direct scanning of the transport stream of interest (see step 56) to create, populate and/or update and provide a comprehensive database of metadata and information stored in the MS 22 with respect to any given multimedia or video content stream available over the network (see step 58).

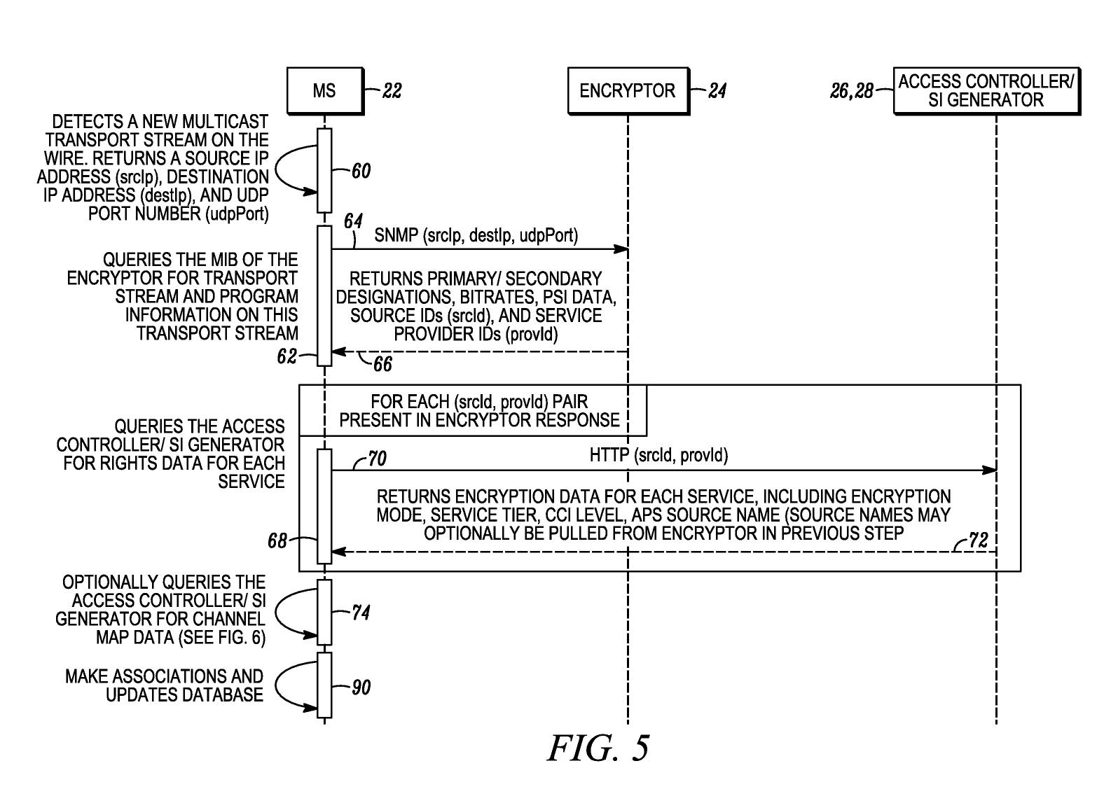

By way of example, FIG. 5 discloses an embodiment of obtaining additional data, such as encryption, PSI, and program ID data from a network encryptor 26, digital access controller 26 and SI generator 28. These headend devices are referenced only by way of example and other headend devices could be substituted therefor. The network encryptor 26, digital access controller 28, and SI generator 30 provide examples of devices that may be widely deployed in networks and are designed to support standard access methods to rights/encryption data, bandwidth, redundancy, channel map, PSI data and the like. However, any other headend device permitting access to information concerning content streams on the network could be substituted for these specific devices.

After the module 32 of MS 22 discovers a new multimedia or video content stream available by the headend of the network and collects at least some limited information from the scanning process (see step 60 in FIG. 5), such as the MCAs and port numbers for a multicast stream, this information is used to obtain associated service metadata sets and like information that would be known and stored by the network encryptor 24 at the headend (see step 62). This operation may be performed during the scanning process or may be performed as a batch process after the scanning process is complete for any given transport stream.

When the additional data is to be collected, the module 32 queries the network encryptor 24 for transport stream and program information with respect to a newly discovered and scanned stream (see step 64). In response, the network encryptor 24 may return primary/secondary designations, bitrates, PSI data, source IDs, service provider IDs, and like information to the module 32 (see step 66). Thereafter, the module 32 may use the source IDs, service provider IDs and like information to request and obtain rights data and the like for the stream from the digital access controller 26 and/or SI generator 28 (see step 68). The module 32 transmits a query or request (see step 70), and the digital access controller 26 and/or SI generator 28 return encryption including encryption mode, service tier, CCL level, APS, source name, and like data to the module 32 (see step 72).

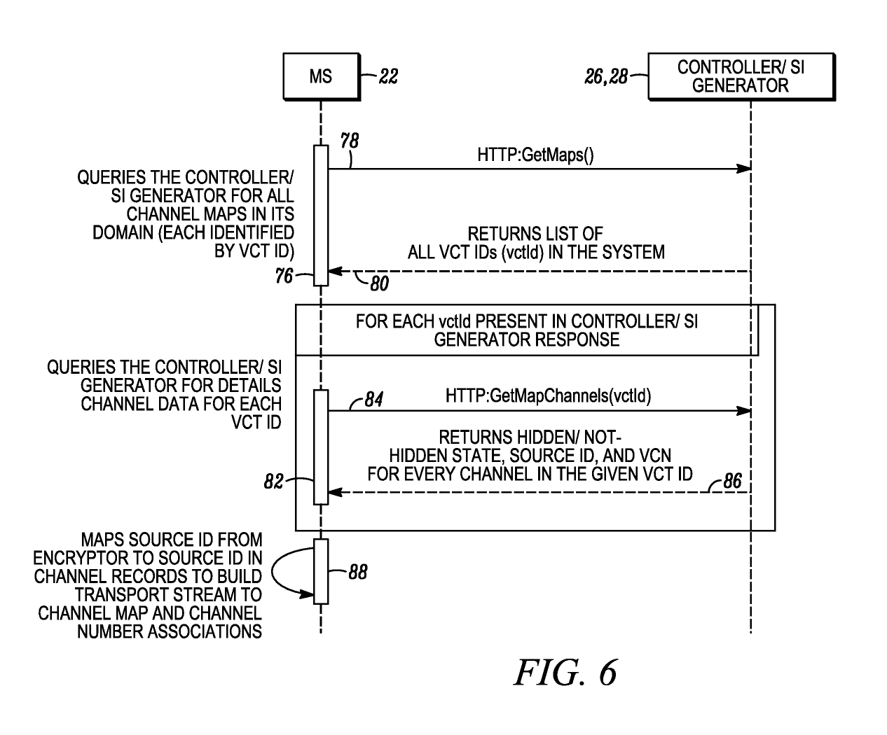

As a further option, the module 32 of the MS 22 may also request channel map data from the digital access controller 26 and/or SI generator 28. See step 74 in FIG. 5, and see FIG. 6 generally. Here, the module 32 may query the digital access controller 26 and/or SI generator 28 for all channel maps in its domain with each being identified by a virtual channel table (VCT) ID (see steps 76 and 78). In response, the digital access controller 26 and/or SI generator 28 returns a list of all VCT IDs in the system (see step 80). Thereafter, the module 32 of the MS 22 may query the digital access controller 26 and/or SI generator 28 for details of channel data for each VCT ID (see steps 82 and 84), and the digital access controller 26 and/or SI generator 28 may return hidden/non-hidden state, source ID, and virtual channel network (VCN) for every channel in the given VCT ID (see step 86). From this information, the module 32 is able to map source ID provided from the network encryptor 24 to source ID provided by the digital access controller 26 and/or SI generator 28 to determine which services are provided on which channel maps and on which channel numbers. In this manner, the module 32 is able to ascertain transport stream to channel map and channel number associations (see step 88).

All the data provided by scanning a given transport stream and by querying and receiving information from network devices concerning the given transport stream is associated and used to populate and update the database stored in the MS 22. See step 90 in FIG. 5. Thus, complete descriptor of use information for content streams available on the network is formed and can be made available to any VPD. This database can be assembled with very little to no operator intervention and can form a queryable and comprehensive database suitable for provisioning downstream devices on the network. In addition, after the metadata database is populated in the above manner, a MSO can use it to build a Content Distribution Network (CDN) for descriptors. In this manner, a downstream VPD can readily locate and process any multimedia or video stream in the CDN.

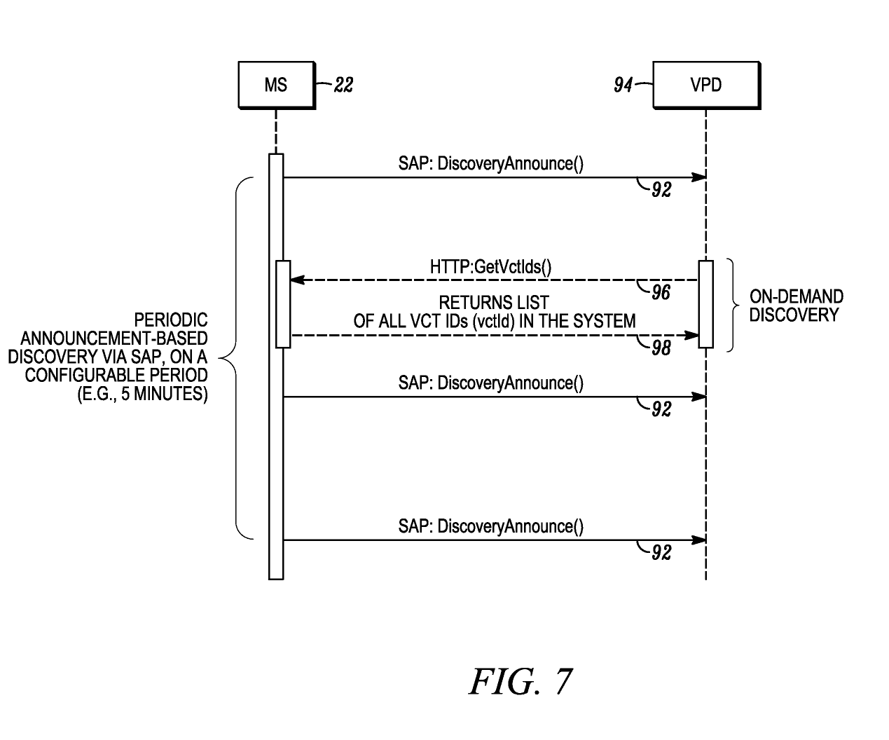

By way of example with respect to the advertising process discussed above, as the module 32 assembles the metadata database in the MS 22, the MS 22 may periodically announce descriptors stored in the database via any suitable protocol, such as SAP. For example, these announcements may be made at 5 minute intervals or the like. See FIG. 7 generally and step 92. As an alternative or in addition to the announcements, a VPD 94 on the network may directly request descriptors on-demand via any suitable protocol, such as web services (see step 96). As an example, the MS 22 receiving such a request may return a list of all VCT IDs in the system to the VPD 94 (see step 98). In this example, the VPD 94 may be located at the headend, customer premise, or any other downstream location on the network.

The devices, units, modules, servers, network interface cards, and storage discussed above can physically be provided on a circuit board or within an electronic device and can include various processors, microprocessors, controllers, chips, disk drives, and the like. It will be apparent to one of ordinary skill in the art that the modules, processors, controllers, units, and the like may be implemented as electronic components, software, hardware or a combination of hardware and software.

While the principles of the invention have been described above in connection with specific devices, systems, and methods, it is to be clearly understood that this description is made only by way of example and not as limitation on the scope of the invention as defined in the appended claims.

I claim:

1. A method of constructing a metadata database of descriptor of use information relative to video and multimedia transport streams capable of being distributed across a network, comprising the steps of:
electronically scanning a transport stream of interest available on the network to detect metadata directly from the transport stream of interest;
electronically collecting additional metadata concerning the transport stream of interest from at least one network device; and
electronically storing the metadata and additional metadata obtained for the transport stream of interest in the metadata database.

2. A method according to claim 1, wherein said scanning, collecting, and storing steps are performed automatically and autonomously by a network server located at a headend of the network.

3. A method according to claim 1, wherein the metadata detected during said scanning step is used during said collecting step to identify the transport stream of interest to the at least one network device so that the additional metadata concerning the transport stream of interest is obtainable from the at least one network device.

4. A method according to claim 1, further comprising the step of associating the metadata detected by said scanning step for the transport stream of interest and the additional metadata obtained by said collecting step for the transport stream of interest in the metadata database.

5. A method according to claim 1, further comprising the step of discovering the transport stream of interest on the network before said scanning step.

6. A method according to claim 5, wherein said discovering step includes monitoring traffic of transport streams on the network by snooping at least one of Internet Group Management Protocol (IGMP) membership report messages and Multicast Listener Discovery (MLD) protocol messages on the network.

7. A method according to claim 5, wherein said discovering step includes iteratively joining transport streams in an address range of transport streams to at least momentarily analyze the transport streams in the address range.

8. A method according to claim 1, wherein the metadata detected during said scanning step includes at least one of transmission source address, user database protocol (UDP) port, and destination address.

9. A method according to claim 1, wherein the additional metadata detected during said collecting step includes at least one of source IDs, provider IDs, bitrates, program-specific information (PSI) data, encryption data, and channel map data.

10. A method according to claim 1, wherein the at least one network device is at least one of a network encryptor, digital addressable controller, SI generator, and video processing device located at a headend of the network.

11. A method according to claim 1, wherein the transport stream of interest is at least one of Internet protocol (IP) traffic, IP multicast traffic, multi-screen video stream, over-the-top (OTT) video stream, and broadcast stream.

12. A method according to claim 1, further comprising the step of announcing a descriptor of use for the transport stream of interest from the metadata database over the network to downstream video processing devices.

13. A method according to claim 1, further comprising the step of electronically receiving a request for a descriptor of use for the transport stream of interest from a downstream video processing device.

14. A method according to claim 1, wherein said collecting step includes transmitting an electronic request to the at least one network device for the additional metadata and receiving a return electronic transmission from the at least one network device.

15. A method according to claim 1, wherein said scanning step occurs before said collecting step.

16. A signal processing electronic device for automatically constructing a metadata database of descriptor of use information of transport streams capable of being distributed across a network, comprising at least one module of an electronic device for directly scanning a video transport stream of interest for metadata concerning the video transport stream of interest, for collecting additional metadata known by other network devices concerning the video transport stream of interest, and for populating the metadata database with the metadata and additional metadata concerning descriptor of use information for the video transport stream of interest.

17. A signal processing electronic device according to claim 16, wherein said module has at least one network interface card (NIC) for scanning the transport stream of interest for the metadata, for configuring an algorithm used for scanning, and for announcing the metadata to downstream video processing devices.

18. A signal processing electronic device according to claim 16, wherein said module forms part of a metadata server located at a headend of the network, and wherein the metadata database is stored in the metadata server and is available to provision downstream video processing devices on the network for processing the transport stream of interest.

19. A signal processing electronic device according to claim 18, wherein said module of said metadata server is in communication with said other network devices which are located at said headend so that said module is able to query and receive the additional metadata from said other network devices.

20. A signal processing electronic device according to claim 19, wherein said other network devices include at least one of a network encryptor, digital addressable controller, SI generator, and video processing device.
